(19) United States
(12) Patent Application Publication
(10) Pub. No.: US 2003/0039775 A1
(43) Pub. Date: Feb. 27, 2003

(54) Multilayer sleeve labels

(76) Inventor: Dan-Cheng Kong, Fairport, NY (US)

Correspondence Address: ExxonMobil Chemical Company, P.O. Box 2149, Baytown, TX, 77522, US

(21) Appl. No.: 09/932,523

(22) Filed: Aug. 17, 2001

(51) Int. Cl. F16B 4/00

(52) U.S. Cl. 428/34.9; 428/500; 428/512; 428/515

(57) ABSTRACT

A thermoplastic film comprising a core layer comprising about 60 wt % to about 95 wt % of a polylactic acid having a D-lactic acid level from about 1 mol % to about 8 mol %, and about 5 wt % to about 40 wt % of a toughening additive, wherein the core layer comprises the interior of the film.

### BACKGROUND OF THE INVENTION

1. Field of the Invention

The invention relates to a film comprising a base layer that comprises polylactic acid and a toughening agent, and a skin layer prepared from a polylactic acid. The invention also relates to a process for the manufacture of a film of this type and its use as a label.

2. Description of the Prior Art

In many label applications, it is desirable that the label stock from which the labels are cut is a film of polymeric material rather than paper. Polymeric film can provide properties lacking in paper, such as durability, strength, water resistance, abrasion resistance, gloss, transparency and other properties. Obviously, the polymeric material must meet the practical requirements of commercial manufacture and use. Material costs must be competitive. The film must be formable by a suitable commercial process such as cast film extrusion or blown film extrusion, requiring that the molten film material be flowable to the correct degree to accomplish proper film formation. The formed film must be capable of hot-stretching without deleterious effect, since it is generally advantageous to hot-stretch and anneal the formed film, so as to orient the film and impart a stiffness to the film that is different in machine and cross directions.

It is already known to surround cylindrical or generally cylindrical packaging units, such as bottles or cans, with overall labels covering their entire circumference; these overall labels are called sleeves. The films used for this purpose are, for example, made of polyethylene, polybutylene, polystyrene, polyethylene-polypropylene copolymers, ethylene-vinyl acetate copolymers and various blends, but in particular of polyvinyl chloride. To obtain shrink properties of the films in the circumferential direction of the overall labels, which are appropriate for the intended purpose, the films are in general biaxially stretch-oriented, for example, according to the bubble, stenter or calender process, particular attention being paid to orientation in the transverse direction. In order to ensure an absolutely crease-free, close contact between the overall label and the packaging unit, the shrink values required are, for example: transverse shrink about 15 to 40% and longitudinal shrink not more than 2 to 5%, at a temperature of 90° C. and a treating time of 15 minutes in a circulating air oven.

In addition, the shrink films are provided with a printing, for example by the reverse printing process, and are subsequently glued or welded to form a tubing. Due to the controlled transverse shrink, the tubing shrinks tightly and crease-free around the packaging unit in the shrink tunnel. The label is applied automatically with the aid of brushes or optionally also by hand. In addition to the desired shrink, the overall labels can possess some of the following properties: high gloss, optical clarity, good slip and rigidity for the automatic application of the label, good printability and good weldability/bondability.

For an economical fabrication of overall labels it is also advantageous to have heat-sealable films. Compared with gluing or welding, less time is required for sealing and, in addition, it is possible to save material.

There has been a trend in the packaging industry, and particularly in the beverage segment thereof, to replace inventory stock of lithographically preprinted cans with blank cans which can be filled as desired, the specific labeling being done by applying to the container a printed label formed from a heat shrink film some time soon before or after the filling operation. This technique is particularly attractive, for example, to breweries who often bottle and package their products under a variety of trade names. By utilizing the shrink labeling process, these bottlers would no longer be required to stock a large inventory of pre-printed containers for each brand and could, instead, stock only unprinted containers together with a supply of the appropriate heat shrinkable printed film labels. Moreover, the presence of the film label around the can would provide additional protection against the printed cans rubbing together during transport. Thus, surfaces of conventional lithographed cans are sufficiently abrasive such that the continuous contact with surrounding cans during shipping after causes small holes to be found in the cans, resulting in “leakers” which must be discarded.

U.S. Pat. No. 6,113,996 discloses a uniaxially heat-shrinkable, biaxially oriented, multilayer film having a polypropylene-containing core layer comprising at least 70 wt. % of said multilayer film and optionally, at least one polyolefin-containing skin layer adjacent said core layer, is prepared by biaxially orienting a coextrudate and therefore orienting said coextrudate by stretching 10 to 40% in the machine direction. The core layer contains isotactic polypropylene and a sufficient amount of syndiotactic polypropylene to inhibit uniaxial heat shrinkage at temperature below about 50° C. The skin layer can be selected from the group consisting of polypropylene, ethylene-propylene copolymer, polyethylene, and ethylene-propylene-butylene terpolymer. U.S. Pat. No. 6,113,996 is incorporated herein by reference in its entirety.

U.S. Pat. No. 6,025,079 discloses a heat shrinkable multilayer film which includes a core layer including a blend having ethylene/propylene copolymer and propylene homopolymer, or ethylene/propylene/propylene/butene-1 terpolymer and propylene homopolymer; and two outer layers each including at least 50%, by weight of each respective outer layer, of ethylene/propylene/butene-1 terpolymer, ethylene/propylene copolymer, or a blend of ethylene/propylene/butene-1 terpolymer and ethylene/propylene copolymer. U.S. Pat. No. 6,025,079 is incorporated herein by reference in its entirety.

U.S. Pat. No. 5,709,937 discloses a machine-direction oriented polypropylene homopolymer and propylene copolymer films wherein the propylene copolymer is one selected from the group consisting of propylene-ethylene copolymers containing up to about 10% by weight of ethylene and propylene-1-butene copolymers containing up to about 15% by weight of 1-butene wherein the oriented films has an opacity of less than about 10% and a haze of about 10% or less in the machine-direction and in the cross-direction. U.S. Pat. No. 5,709,937 is incorporated herein by reference in its entirety.

U.S. Pat. No. 5,524,778 discloses a container of thermoplastic material having a label which substantially covers the visible outer surface of the body of the container. The container is made either as a single layer or multi-layer extrusion. The layer of the container which is visible from the outside is made from 10% to 100% recycled plastic. The label is made of substantially the same material as the container so that both may be recycled without removing the label. U.S. Pat. No. 5,524,778 is incorporated herein by reference in its entirety.

U.S. Pat. No. 5,443,895 discloses a transparent shrinkable film comprising a base layer prepared from propylene-containing polymers and a hydrocarbon resin. The base layer contains about 5 to 40% by weight of a propylene homopolymer, 0 to about 30% by weight of a hydrogenated hydrocarbon resin having a softening point in the range from about 80° to 125° C., and about 30 to 95% by weight of a random ethylene-propylene copolymer, the percentages being related to the total weight of the mixture. A top layer is arranged on either side of the base layer. The invention also describes a process for the manufacture of the film. U.S. Pat. No. 5,443,895 is incorporated herein by reference in its entirety.

U.S. Pat. No. 5,252,155 discloses a process for applying heat shrink film to containers comprising the steps of a) coating at least a portion of a heat shrinkable but unshrunken film segment with a reactive hot melt polyurethane adhesive having a free isocyante content greater than 2% and a viscosity less than 3000 cps at 225° F.; b) applying the film to the longitudinal surface of the container; and, c) subjecting the container to heat to shrink the film onto the container so as to permanently affix it thereto. U.S. Pat. No. 5,252,155 is incorporated herein by reference in its entirety.

U.S. Pat. No. 6,183,814 discloses a coated paper product including a paper layer and a polymer layer, wherein the polymer layer includes a polylactide polymer composition having a ratio of Mz to Mn of greater than about 6. The polymer composition, when melted, exhibits a die swell of greater than about 1.25 for a melt flow index of greater than about 2. Polymer lactide compositions, methods of manufacturing the polymer composition and the coated paper product, and articles produced therefrom are also described. U.S. Pat. No. 6,183,814 is incorporated herein by reference in its entirety.

U.S. Pat. No. 6,168,857 discloses compositions and methods for manufacturing sheets having a starch-bound matrix reinforced with fibers and optionally including an inorganic mineral filler. Suitable mixtures for forming the sheets are prepared by mixing together water, unmodified and ungelatinized starch granules, an auxiliary water-dispersible organic polymer, fibers, and optionally an inorganic mineral filler in the correct proportions to form a sheet having desired properties. The mixtures are formed into sheets by passing them between one or more sets of heated rollers to form green sheets. The heated rollers cause the auxiliary polymer to form a skin on the outer surfaces of the sheet that prevents the starch granules from causing the sheet to adhere to the rollers upon gelation of the starch. The green sheets are passed between heated rollers to gelatinize the starch granules, and then to dry the sheet by removing a substantial portion of the water by evaporation. The starch and auxiliary polymer form the binding matrix of the sheets with the fibers and optional inorganic filler dispersed throughout the binding matrix. The starch-bound sheets can be cut, rolled, pressed, scored, perforated, folded, and glued to fashion articles from the sheets much like paper or paperboard. The sheets are particularly useful in the mass production of containers, such as food and beverage containers. U.S. Pat. No. 6,168,857 is incorporated herein by reference in its entirety.

U.S. Pat. No. 6,153,276 discloses a heat-sealable lactic acid-based polymer laminates which have heat resistance of 60° C. or above, high sealing strength and good biodegradability and are useful in various films, sheets, packaging containers, etc., comprising a base layer (I) made of a crystallized lactic acid-based polymer (A) and a sealing layer (II) made of an amorphous lactic acid-based polymer (B) having a softening point lower than the melting point of said lactic acid-based polymer (A), and films, sheets or packaging containers with the use of these laminates. U.S. Pat. No. 6,153,276 is incorporated herein by reference in its entirety.

U.S. Pat. No. 6,080,478 discloses a multi-layer material including a cellulose-based naturally decomposing basic layer, at least one polyhydroxyalkanoate layer on the basic layer and at least one biodegradable polylactide layer between the basic layer and the at least one polyhydroxyalkanoate layer. U.S. Pat. No. 6,080,478 is incorporated herein by reference in its entirety.

### SUMMARY OF THE INVENTION

In accordance with the present invention, there is provided a polymer film possessing a low coefficient of friction, which comprises:

(a) a core layer comprising a polylactic acid and a toughening additive wherein the core layer comprises the interior of the film; and optionally

(b) a first skin layer comprising a polylactic acid, wherein the first skin layer is exterior to the core layer.

Accordingly, it is an object of the present invention to provide a multi-layer film comprising a core layer comprising a polylactic acid and a toughening additive and a skin layer comprising a polylactic acid, for use in sleeve labels, which has good bonding and shrinking characteristics, good optical and mechanical properties, and is sealable. A further object of the present invention is to provide a process for producing the foregoing film.

There has been provided, in accordance with one aspect of the present invention, a shrinkable film comprising a core layer comprising a polylactic acid and a toughening additive; an optional transition layer comprising a mixture of the core layer material and the skin layer material; and a skin layer comprising a polylactic acid.

In accordance with another aspect of the present invention there is provided a process for producing the foregoing film which comprises the steps of producing a film by coextrusion through a slot die, solidifying the cast film on a chill roll and orienting the film by stretching in the longitudinal and transverse directions, wherein longitudinal stretching is carried out at a temperature between about 60° C. to about 138° C. and at a stretching ratio of less than 3, and wherein transverse stretching is carried out at a temperature between about 90° C. to about 138° C. at a stretching ratio of more than 6.

Advantages of the thermoplastic label include one or more of the following:

1. High surface energy for printing

2. Lower shrink force than an OPP shrink label

3. A label material that is better for the environment than a polyolefin label.

4. A label that can be recycled with the plastic container without having to be removed.

5. Improved adhesion of a lap seal.

6. A sleeve label that has a solvent seal for a sleeve that does not shrink.

7. A label that can be used to replace printing in packaging and container applications.

8. A label with enhanced environmental appeal.

9. A label that exhibits enhanced shrinkage properties

Other objects, features and advantages of the present invention will become apparent to those skilled in the art from the following detailed description. It should be understood, however, that the detailed description and specific examples, while indicating preferred embodiments of the present invention, are given by way of illustration and not limitation. Many changes and modifications within the scope of the present invention may be made without departing from the spirit thereof, and the invention includes all such modifications.

### BRIEF DESCRIPTION OF THE DRAWINGS

The novel features believed characteristic of the invention are set forth in the appended claims. The invention itself however, as well as a preferred mode of use, further objects and advantages thereof, will best be understood by reference to the following detailed description of several illustrative embodiments when read in conjunction with the accompanying drawings, wherein:

FIG. 1 is a cross sectional view of a five layered film;

FIG. 2 is a cross sectional view of a three layered film;

FIG. 3 is a cross sectional view of a four layered film; and

FIG. 4 is a cross sectional view of a two layered film.

### DETAILED DESCRIPTION OF THE DRAWINGS

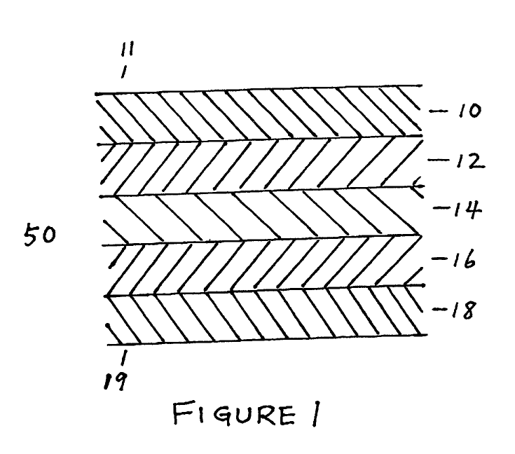

Referring now to FIG. 1 is a cross sectional view of a five layered film 50. The film 50 is comprised of a first surface 11, a first skin layer 10, a first intermediate or transition layer 12, a core layer 14, a second intermediate or transition layer 16, a second skin layer 18, and a second surface 19.

In one embodiment of a five layered film 50, the core layer 14 comprises a polylactic acid and a toughening additive.

In a second embodiment, the core layer 14 comprises a polylactic acid and a toughening additive as in the first embodiment, and the first skin layer 10 comprises a polylactic acid. In alternative embodiments, each of the first skin layer 10, the first intermediate or transition layer 12, the second intermediate or transition layer 16, and/or the second skin layer 18 may comprise a polylactic acid and/or a toughening additive.

In a third embodiment of a five layered film 50, the first surface 11 of the first skin layer 10 is treated and the core layer 14 comprises a polylactic acid and a toughening additive as in the first embodiment, and the the first skin layer 10, the first intermediate or transition layer 12, the second intermediate or transition layer 16, and/or the second skin layer 18 comprise a polylactic acid. Possible treatments for the first surface 11 include corona discharge, flame, and plasma treatment.

In a fourth embodiment of a five layered film 50, the first surface 11 of the first skin layer 10 is treated, the second surface 19 of the second skin layer 18 is treated, and the core layer 14 comprises a polylactic acid and a toughening additive as in the first embodiment, and the the first skin layer 10, the first intermediate or transition layer 12, the second intermediate or transition layer 16, and/or the second skin layer 18 comprise a polylactic acid. Possible treatments for the first surface 11 and the second surface 19 include corona discharge, flame, and plasma treatment.

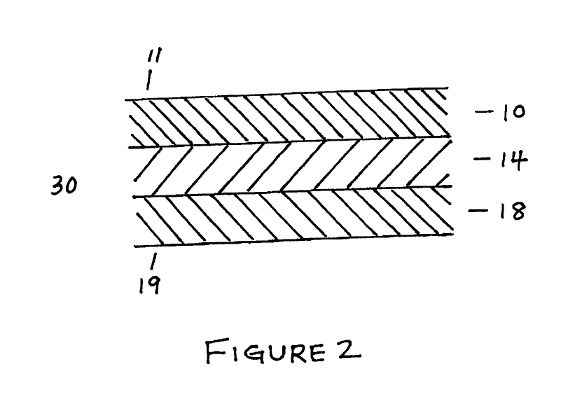

Referring now to FIG. 2 is a cross sectional view of a three layered film 30. The film 30 is comprised of a first surface 11, a first skin layer 10, a core layer 14, a second skin layer 18, and a second surface 19.

In one embodiment of a three layered film 30, the core layer 14 comprises a polylactic acid and a toughening additive.

In a second embodiment of a three layered film 30, the first surface 11 of the first skin layer 10 is treated, the core layer 14 comprises a polylactic acid and a toughening additive as in the first embodiment, and the first skin layer 10 comprises a polylactic acid. In alternative embodiments, each of the first skin layer 10 and/or the second skin layer 18, may comprise a polylactic acid and/or a toughening additive. Possible treatments for the first surface 11 include corona discharge, flame, and plasma treatment.

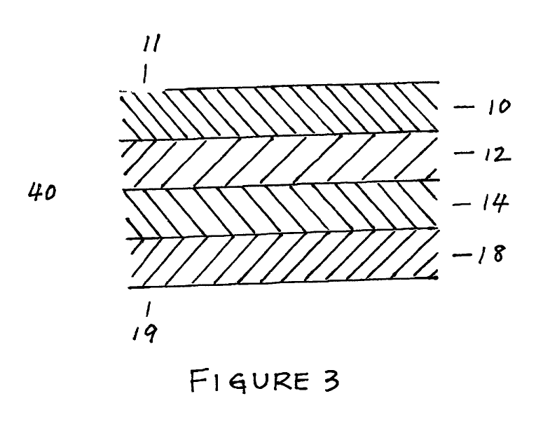

Referring now to FIG. 3 is a cross sectional view of a four layered film 40. The film 40 is comprised of a first surface 11, a first skin layer 10, a first transition layer 12, a core layer 14, a second skin layer 18, and a second surface 19.

In one embodiment of a four layered film 40, the core layer 14 comprises a polylactic acid and a toughening additive.

In a second embodiment of a four layered film 40, the first surface 11 of the first skin layer 10 is treated and the core layer 14 comprises a polylactic acid and a toughening additive. Possible treatments for the first surface 11 include corona discharge, flame, and plasma treatment. In alternative embodiment, each of the first skin layer 10, the first transition layer 12, and/or the second skin layer 18 may comprise a polylactic acid and/or a toughening additive

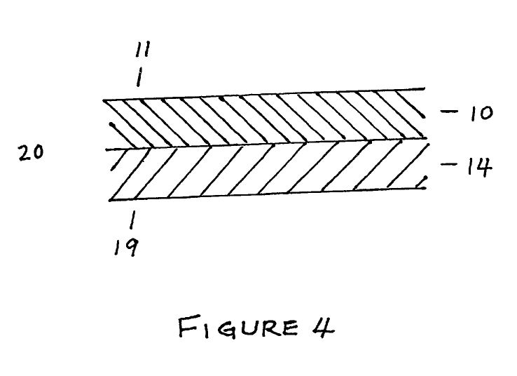

Referring now to FIG. 4 is a cross sectional view of a two layered film 20. The film 20 is comprised of a first surface 11, a first skin layer 10, a core layer 14, and a second surface 19.

In one embodiment of a two layered film 20, the core layer 14 comprises a polylactic acid and a toughening additive.

In a second embodiment of a three layered film 30, the first surface 11 of the first skin layer 10 is treated and the core layer 14 comprises a polylactic acid and a toughening additive, and the first skin layer 10 comprises a polylactic acid and/or a toughening additive. Possible treatments for the first surface 11 include corona discharge, flame, and plasma treatment.

In an alternative embodiment, a one-layer film (not shown) may be produced. The one-layer film comprises a core layer that comprises a polylactic acid and a toughening additive.

In one embodiment, the core layer 14 of film 50, film 30, and film 40 is a thermoplastic polymeric matrix material within which is preferably located a stratum of voids. From this it is to be understood that the voids create the matrix configuration. The opacity and low light transmission of the film may be enhanced by the addition to the core layer 14 of at least about 1% by weight and up to about 10% by weight of void initiating on opacifying compounds, which are added to the melt mixture of the core layer 14 before extrusion. Opacifying compounds which may be used include iron oxides, carbon black, aluminum, TiO₂, and talc. Although one embodiment has a strata of voids located in the core layer 14, it is possible to form an opaque core layer 14 that is substantially free of voids where the opacity is achieved by the addition of opacifying compounds.

In one embodiment, from about 3% to about 9% by weight of inorganic particulate material such as TiO₂ and/or talc is added to the melt mixture of the core layer 14 before extrusion.

In one embodiment, when forming the core layer 14, as in U.S. Pat. Nos. 4,377,616; 4,632,869; 5,176,954; 5,397,635; 5,972,490; 4,758,396; 4,758,462; 4,652,489; 4,741,950; 4,594,211; and 6,004,664 the disclosures of which are incorporated herein by reference in their entirety, a master batch technique can be employed by either forming the void initiating particles in situ or in adding preformed spheres to a molten thermoplastic matrix material. After the formation of a master batch, appropriate dilution of the system can be made by adding additional thermoplastic matrix material until the desired proportions are obtained. However, the components may also be directly mixed and extruded instead of utilizing a master batch method.

The void-initiating particles which are added as filler to the polymer matrix material of the core layer 14 can be any suitable organic or inorganic material which is incompatible with the core material at the temperature of biaxial orientation such as polybutylene terephthalate, nylon, solid or hollow preformed glass spheres, metal beads or spheres, ceramic spheres, calcium carbonate, COC's (cyclic olefin polymers and cyclic olefin copolymers), etc.

In another embodiment, the void-initiating particle material is incompatible with the core material, at least at the temperature of biaxial orientation. As a result of the biaxial orientation of the film structure herein, in addition to opacifying the core layer 14 of the structure, the orientation improves other physical properties of the composite layers such as flex-crack resistance, Elmendorff tear strength, elongation, tensile strength, impact strength and cold strength properties. The resulting film can have, in addition to a rich high quality appearance and excellent opacifying characteristics, low water vapor transmission rate characteristics and low oxygen transmission rate characteristics. This makes the film ideally suited for packaging food products including liquids. The film also has attractive utility as a decorative wrap material.

The polymers contemplated as the material in the core layer 14 include polylactic acid, in one embodiment having a D-lactic acid level of about 1% to about 8%, polypropylene, polyethylene, polybutene and copolymers and blends thereof.

In another embodiment, a conventional filler and pigment such as titanium dioxide may be added to the core layer 14 and may be desirable for printing or graphic reproduction purposes. Generally, from an economic viewpoint at least it has not been considered to be of any particular advantage to use more than about 10% by weight of titanium dioxide to achieve a white label suitable for printing, although greater amounts could be added for greater opacity so long as there is no undue interference with achieving the desired properties of a thermoplastic label. It should be noted that the core layer may contain other materials in addition to the materials broadly described above, so long as these other materials do not unduly interfere with achieving the desired advantages of the invention.

The polymers contemplated as the material in the first skin layer 10 and/or second skin layer 18 are selected from the group consisting of polylactic acid, a toughening additive, and blends thereof. In one embodiment the polylactic acid has a D-lactic acid level of at least about 8%.

In one embodiment, the thickness of the first skin layer 10 and the second skin layer 18 is less than about 5 microns. In another embodiment, the thickness of the first skin layer 10 and the second skin layer 18 is less than about 2 microns. In a third embodiment, the thickness of the first skin layer 10 and the second skin layer 18 is less than about 1 micron.

The first skin layer 10 and the second skin layer 18 may be compounded with an anti-blocking effective amount of an anti-blocking agent, e.g., silica, clays, talc, glass, and the like, which may be provided in the form of approximately spheroidal particles. The major proportion of these particles, for example, anywhere from more than half to as high as 90 wt % or more, may be of such a size that a significant portion of their surface area, for example, from about 10 to about 70% thereof, will extend beyond the exposed first surface 11 or second surface 19.

The first skin layer 10 and/or the second skin layer 18 can also contain pigments, fillers, stabilizers, light protective agents or other suitable modifying ingredients if desired.

The polymers contemplated as the material in the first transition layer 12 and/or second transition layer 16 may be selected from those polymers commonly used in film manufacture. In another embodiment, the material in the first transition layer 12 and/or second transition layer 16 is selected from the group consisting of polylactic acid, the material used in first skin layer 10 and/or the second skin layer 18, the material used in the core layer 14, and blends thereof.

In another embodiment, the first skin layer 10, the first transition layer 12, the core layer 14, the second transition layer 16 and/or the second skin layer 18, may comprise a polylactic acid and/or a toughening additive. In one embodiment, the first skin layer 10, the first transition layer 12, the core layer 14, the second transition layer 16 and/or the second skin layer 18, may comprise from about 60 wt % to about 95 wt % of a polylactic acid having a D-lactic acid level from about 1% to about 8% (by mole). In another embodiment, the first skin layer 10, the first transition layer 12, the core layer 14, the second transition layer 16 and/or the second skin layer 18, may comprise from about 60 wt % to about 95 wt % of a polylactic acid, having a D-lactic acid level of at least about 8% (by mole). In another embodiment, the first skin layer 10, the first transition layer 12, the core layer 14, the second transition layer 16 and/or the second skin layer 18, may comprise from about 5 wt % to about 40 wt % of a toughening additive. The toughening additive may enable the film to have an increased elongation to break to facilitate processing. In another embodiment, the polylactic acid and/or the toughening additive may be incorporated into the layer by a masterbatch which includes a polylactic acid and/or a toughening additive. In another embodiment, the polylactic acid and/or a toughening additive is mixed directly into one or more of the layers. Suitable toughening additives include poly(epsilon-caprolactone) (available from Union Carbide as Tone 787); metallocene plastomers (available from Exxon Chemical Co. as Exact 0203); styrene-ethylene-butene-styrene (SEBS) block copolymers (available from Asahi Chemical as Tuftec L515); polyethylene succinate (available from Nippon Shokubai as Lunare SE); polybutylene succinate/adipate (available from Showa Highpolymer as Bionelle); polybutylene succinate/carbonate (available from Mitsubishi Gas Chemical as U-Vec); polyethylene; and polyurethane (available from BF Goodrich Chemical Co. as Estane 58246). Suitable polylactic acids EcoPLA 4030D, EcoPLA 4040D, EcoPLA 4050D, and EcoPLA 4060D all available from Dow-Cargill Polymers LLC.

The polylactic acid and/or the toughening additive may be incorporated homogeneously in the first skin layer 10, the second skin layer 18, the core layer 14, the first transition layer 12, and/or the second transition layer 16. This can be achieved by either incorporating the polylactic acid and/or the toughening additive as a pellet, a dispersion, or emulsion at room temperature and then heating the blend with the application of shearing forces or by incorporating the additive while the blend is being melted. The mixing temperature must be high enough to soften the blend and enable a very uniform mixture to be formed. The temperature required in a kneader or extruder is generally from about 170° C. to about 230° C.

In one embodiment, the first skin layer 10, the second skin layer 18, the core layer 14, the first transition layer 12, and/or the second transition layer 16 may comprise greater than about 50% by weight of the polylactic acid. In another embodiment, the first skin layer 10, the second skin layer 18, the core layer 14, the first transition layer 12, and/or the second transition layer 16 may comprise greater than about 60% by weight of the polylactic acid. In another embodiment, the first skin layer 10, the second skin layer 18, the core layer 14, the first transition layer 12, and/or the second transition layer 16 may comprise from about 70% by weight to about 90% by weight of the polylactic acid. In another embodiment, the first skin layer 10, the second skin layer 18, the core layer 14, the first transition layer 12, and/or the second transition layer 16 may comprise from about 1% by weight to about 30% by weight of the toughening additive, in another embodiment from about 3% by weight to about 20% by weight of the toughening additive, and in another embodiment from about 5% by weight to about 10% by weight of the toughening additive.

In one embodiment, the exposed first surface 11 and/or second surface 19 are treated in a known and conventional manner, e.g., by corona discharge to improve its receptivity to inks and/or its suitability for such subsequent manufacturing operations as lamination.

In one embodiment, the exposed treated or untreated first surface 11 and/or second surface 19 have applied to it, coating compositions or substrates such as another polymer film or laminate; a metal foil such as aluminum foil; cellulosic webs, e.g. numerous varieties of paper such as corrugated paperboard, craft paper, glassine, cartonboard; non-woven tissue, e.g., spunbonded polyolefin fiber, melt-blown microfibers, etc. The application may employ a suitable adhesive, e.g., a hot melt adhesive such as low density polyethylene, ethylene-methacrylate copolymer, water-based adhesive such as polyvinylidene chloride latex, and the like.

In one embodiment, the film of the present invention is extrusion laminated to another polyolefin film.

In one embodiment, the first skin layer 10, first transition layer 12, core layer 14, second transition layer 16, and/or second skin layer 18 are coextruded. Thereafter, the film may be biaxially oriented. For example, a machine direction orientation is preferably from about 1.1 to about 6 times and a transverse orientation, and is preferably from about 2 to about 10 times at a drawing temperature of about 100° C. to 138° C. to yield a biaxially oriented film. The film thickness is from 0.5 mil to 1.0 mils. A preferred film thickness is from about 0.5 mil to about 5 mils. Specifically the film thickness is from 1 mil to 3 mils. In another embodiment, the film is uniaxially oriented. In another embodiment, the thermoplastic label is uniaxially oriented from about 1.1 to about 6 times in the machine direction.

In another embodiment the first skin layer 10 and/or the second skin layer 18 has a coating or metal layer applied. U.S. Pat. Nos. 6,077,602; 6,013,353; 5,981,079; 5,972,496; 6,074,762; 6,025,059; and 5,888,648 disclose the use of coatings and/or metal layers on a film, and are disclosed herein by reference. In one embodiment, suitable coatings may include PVdC's or acrylics which serve to boost gloss, enhance machineability, and/or enhance ink adhesion; suitable metals may include aluminum. In another embodiment, the first skin layer 10 and/or the second skin layer 18 are printable. In one embodiment, a coating is applied to the first skin layer 10 and/or the second skin layer 18. The coating may be selected from the group comprising sulfonated polyester, iminated butyl-acrylate copolymer, iminated alky-acrylate copolymers, ionomeric polymer, urethane type copolymer coatings, and acrylic nitrile copolymers.

In one embodiment, the film may be used as a packaging material or label. Any adhesive commonly used in the art may be used to attach the film to itself or another surface. In another embodiment, if the first skin layer 10 and/or the second skin layer 18 comprise a polylactic acid having a D-lactic acid level of at least about 8%, then the film may be attached to itself using a solvent seal technique for a lap seal and/or a fin seal.

Although certain preferred embodiments have been disclosed for the five layer film 50, three layer film 30, four layer film 40, and two layer film 20, additional embodiments of films with three or more layers are possible by interchanging elements already disclosed that would be clear to one with ordinary skill in the art.

### EXAMPLES

### Example 1

A three layer, A/B/C, biaxially oriented sleeve film is made by tenter frame orientation at 1.35 times in the machine direction and 8 times in the transverse direction. B is a core layer comprising 10 wt % of toughening additive from Union Carbide as Tone-787 and 90 wt % of poly(lactic acid) with D-latic acid level at 1.3 mole % from Cargill-Dow Polymers LLC as EcoPLA4030D. A and C are skin layers comprising poly(lactic acid) with D-lactic acid level at 10 mole % from Cargill-Dow Polymers LLC as EcoPLA4060D. The core layer thickness is about 42 micron and the skin layer is about 3 micron. The sleeve film is lap-sealed into a tube by THF solvent for sleeve label application.

### Example 2

A three layer, A/B/C, biaxially oriented sleeve film is made by tenter frame orientation at 1.35 times in the machine direction and 8 times in the transverse direction. B is a core layer comprising 10 wt % of toughening additive from Union Carbide as Tone-787 and 90 wt % of poly(lactic acid) with D-lactic acid level at 4.2 mole % from Cargill-Dow polymers LLC as EcoPLA4040D. A and C are skin layers comprising poly(lactic acid) with D-lactic acid level at 10 mole % from Cargill-Dow Polymers LLC as EcoPLA4060D. The core layer thickness is about 42 micron and the skin layer is about 3 micron. The sleeve film is lap-sealed into a tube by THF solvent for sleeve label application.

TABLE 1
Film Shrinkage

Shrinkage at 250 F. for 7 minutes

| Sample | MD | TD |
|---|---|---|
| Example 1 | 5.3% | 21.3% |
| Example 2 | 6.0% | 25.2% |

### Example 3

A three layer, A/B/C, biaxially oriented sleeve film is made by tenter frame orientation at 1.35 times in the machine direction and 8 times in the transverse direction. B is a core layer comprising 10 wt % toughening additive from Asahi Chemicals as Tuftec L515 and 90 wt % of poly(lactic acid) with D-latic acid level at 4.2 mole % from Cargill-Dow Polymers LLC as EcoPLA4040D. A and C are skin layers comprising poly(lactic acid) with D-lactic acid label at 10 mole % from Cargill-Dow Polymers LLC as EcoPLA4060D. The core layer thickness is about 30 micron and the skin layer thickness is about 3 micron.

TABLE 2
Film Physical Property

| | | Orientation | | Elongation to break | |
|---|---|---|---|---|---|
| Sample | Polymer | MD × TD | Toughening Additive | MD | TD |
| Control | EcoPLA4040D | 1.35 × 8 | none | 4% | 51% |
| Example-1 | EcoPLA4030D | 1.35 × 8 | Tone-787 (10%) | 128% | 66% |
| Example-2 | EcoPLA4040D | 1.35 × 8 | Tone-787 (10%) | 137% | 62% |
| Example-3 | EcoPLA4040D | 1.35 × 8 | Tuftec L515 (10%) | 171% | 49% |

We claim:

1. A thermoplastic film comprising:
a. a core layer comprising about 60 wt % to about 95 wt % of a polylactic acid having a D-lactic acid level from about 1 mol % to about 8 mol %, and about 5 wt % to about 40 wt % of a toughening additive, wherein the core layer comprises the interior of the film.

2. The thermoplastic film of claim 1 further comprising:
b. a first skin layer comprising a polylactic acid having a D-lactic acid level of at least about 8 mol %, wherein the first skin layer is exterior to the core layer.

3. The thermoplastic film of claim 2 further comprising:
c. a second skin layer comprising a polylactic acid having a D-lactic acid level of at least about 8 mol %, wherein the second skin layer is exterior to the core layer, and on a side of the core layer opposite the first skin layer.

4. The thermoplastic film of claim 2 wherein the first skin layer further comprises a slip additive.

5. The thermoplastic film of claim 2 wherein the first skin layer from about 1 wt % to about 10 wt % of a poly(epsilon-caprolactone).

6. The thermoplastic film of claim 1 wherein the toughening additive is selected from the group consisting of poly(epsilon-caprolactone), metallocene plastomers, styrene-ethylene-butene-styrene (SEBS) block copolymers, polyethylene succinate, polybutylene succinate/adipate, polybutylene succinate/carbonate, polyethylene, polyurethane, and mixtures thereof.

7. The thermoplastic film of claim 1 wherein the core layer is cavitated.

8. The thermoplastic film of claim 7 further comprising an inorganic cavitating agent selected from the group consisting of solid glass spheres, hollow glass spheres, metal beads, metal spheres, ceramic spheres, calcium carbonate, and mixtures thereof.

9. The thermoplastic film of claim 7 wherein the cavitating agent comprises calcium carbonate, and wherein the core layer further comprises high density polyethylene.

10. The thermoplastic film of claim 1 wherein the film has a thickness from about 1 mil to about 5 mils.

11. The thermoplastic film of claim 1 wherein the film has a thickness from about 1 mil to about 10 mils.

12. The thermoplastic film of claim 1 wherein the film is biaxially oriented.

13. A thermoplastic sleeve label adapted to be applied to a container comprising:
a. a core layer comprising about 60 wt % to about 95 wt % of a polylactic acid having a D-lactic acid level from about 1 mol % to about 8 mol %, and about 5 wt % to about 40 wt % of a toughening additive, wherein the core layer comprises the interior of the label; and
b. a first skin layer comprising a polylactic acid having a D-lactic acid level of at least about 8 mol %, wherein the first skin layer is exterior to the core layer.

14. A container having a thermoplastic sleeve label comprising:
a. a surface of the container;
b. an adhesive adjacent to the surface;
c. a label comprising a core layer comprising about 60 wt % to about 95 wt % of a polylactic acid having a D-lactic acid level from about 1 mol % to about 8 mol %, and about 5 wt % to about 40 wt % of a toughening additive, wherein the core layer comprises the interior of the label; and a first skin layer comprising a polylactic acid having a D-lactic acid level of at least about 8 mol %, wherein the first skin layer is exterior to the core layer.

15. The container of claim 14 wherein the label further comprises a second skin layer comprising a polylactic acid having a D-lactic acid level of at least about 8 mol %, wherein the second skin layer is exterior to the core layer, and on a side of the core layer opposite the first skin layer.

16. A process for producing a thermoplastic sleeve label comprising the steps of:
a. coextruding a core layer comprising about 60 wt % to about 95 wt % of a polylactic acid having a D-lactic acid level from about 1 mol % to about 8 mol %, and about 5 wt % to about 40 wt % of a toughening additive, wherein the core layer comprises an interior of the film; and a first skin layer comprising a polylactic acid having a D-lactic acid level of at least about 8 mol %, wherein the first skin layer is exterior to the core layer;
b. orienting said label in the machine direction;
c. heat annealing said label; and
d. treating said label with at least one of plasma, corona, and flame treatment.

17. The process of claim 16, further comprising coextruding the core layer, wherein the core layer further comprises a second skin layer comprising a polyactic acid having a D-lactic acid level of at least about 8 mol %, wherein the second skin layer is exterior to the core layer, and on a side of the core layer opposite the first skin layer.

18. The process of claim 17, further comprising the step of printing said label on at least one of the first skin layer and the second skin layer.

19. The process of claim 16, further comprising the step of printing said label on the first skin layer.

20. The process of claim 16, further comprising the step of forming said label into a tube and sealing said label with a seal selected from the group consisting of solvent seal, heat seal, ultrasonic seal, and adhesive seal.

21. The process of claim 16 further comprising the step of orienting said label in the transverse direction.

22. The process of claim 16 further comprising the steps of:
a. placing said tube onto a container; and
b. shrinking said tube with the application of at least one of heat and UV light.
